(19) United States
(12) Patent Application Publication
(10) Pub. No.: US 2005/0012901 A1
(43) Pub. Date: Jan. 20, 2005

(54) Portable image viewing apparatus

(76) Inventors: William Pan, Taipei (TW); Ssu-Kuang Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/813,089

(22) Filed: Mar. 31, 2004

(30) Foreign Application Priority Data
Jul. 18, 2003 (TW) 92213189

(51) Int. Cl. G03B 17/02

(52) U.S. Cl. 352/242

(57) ABSTRACT

A portable image viewing apparatus includes a casing and a micro display device arranged within the casing. The casing is ergonomically shaped for ease handling by user's hand and is provided with a plurality of buttons thereon for user's operation. The portable image viewing apparatus has a built-in memory or a card reader to access an external memory. Therefore, the portable image viewing apparatus can download image stored in a computer by wired or wireless way.

### FIELD OF THE INVENTION

The present invention relates to a portable image viewing apparatus, especially to a portable image viewing apparatus with a micro display device that can be hold by single hand of user and can be easily operated through buttons provided on the casing thereof.

### BACKGROUND OF THE INVENTION

Medical image or photos such as x-ray photos or CT (computed tomography) images are essential to doctor for the diagnosis of patient. It is a long-existing problem that delivery of x-ray photo to sickroom is time consuming and troublesome.

As the rapid progress of digitalized image, the medical image or photo such as x-ray photos or CT (computed tomography) images can be digitalized and stored in a notebook computer. However, the notebook computer is heavy and bulky to carry and its battery cannot sustain for a long time.

### SUMMARY OF THE INVENTION

It is an object of the present invention to provide a portable image viewing apparatus, which comprises a casing and a micro display device arranged within the casing. It is another object of the present invention to provide a portable image viewing apparatus, which comprises a viewing window and an adjusting part placed outside the viewing window to adjust focal length of the viewing window for observing the micro display.

It is another object of the present invention to provide a portable image viewing apparatus, which comprises a built-in memory or a card reader to access an external memory. Therefore, the portable image viewing apparatus can download image stored in a computer.

The various objects and advantages of the present invention will be more readily understood from the following detailed description when read in conjunction with the appended drawing, in which:

### BRIEF DESCRIPTION OF DRAWINGS

FIG. 1 shows a schematic view of the portable viewing apparatus according to a preferred embodiment of the present invention;

FIG. 2 shows a cross sectional view of the portable viewing apparatus according to a preferred embodiment of the present invention;

FIG. 3 shows an exploded view of the portable viewing apparatus according to a preferred embodiment of the present invention;

FIG. 4 shows a schematic diagram of the portable image viewing apparatus using LCOS display device;

FIG. 5 shows a block diagram of the micro display used in the portable viewing apparatus according to a preferred embodiment of the present invention; and

FIG. 6 depicts the application of the portable viewing apparatus according to the present invention.

### DETAILED DESCRIPTION OF THE INVENTION

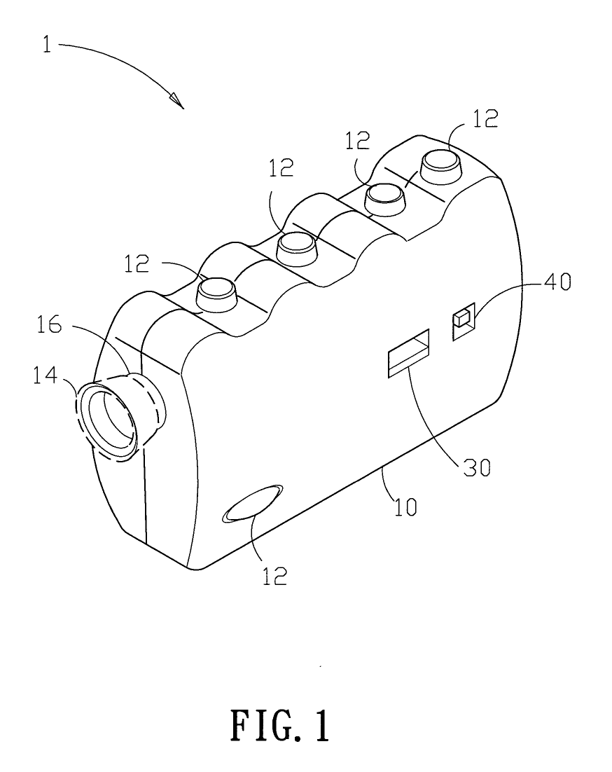

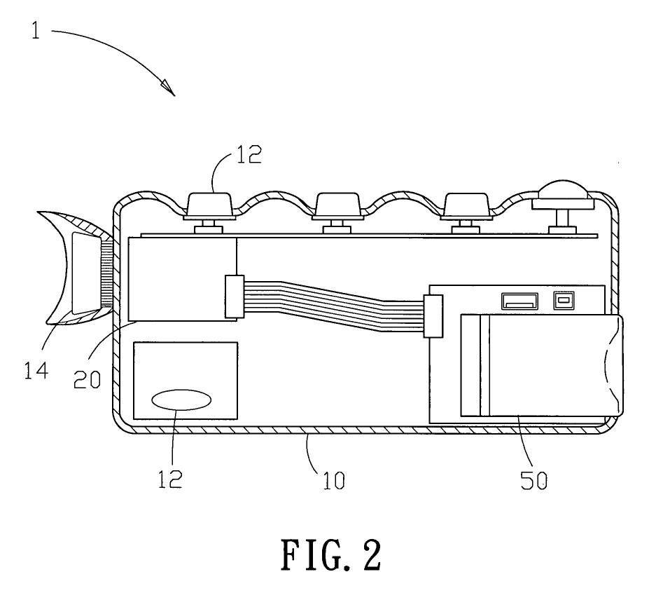

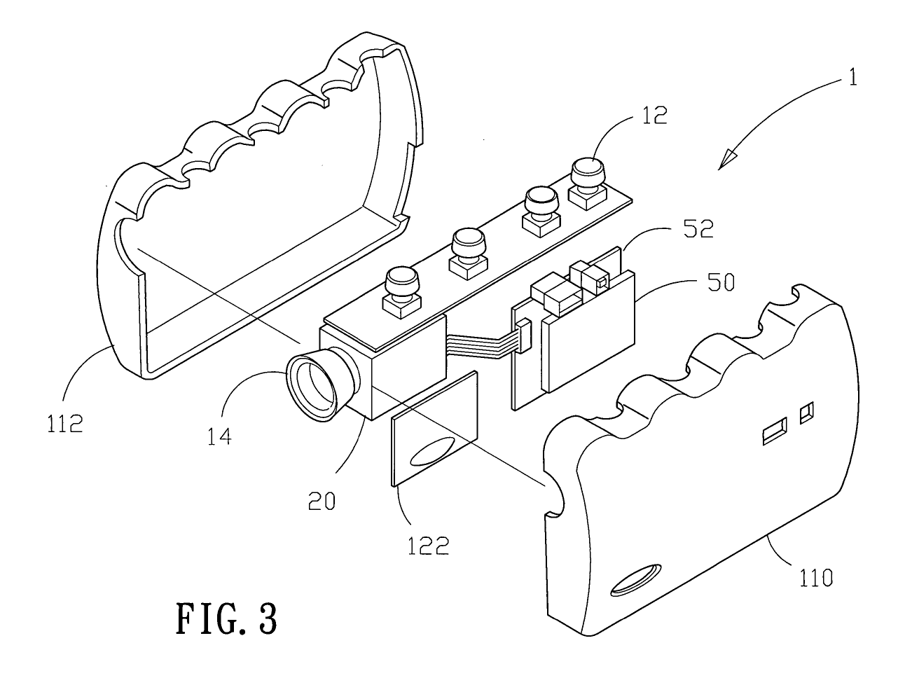

With reference now to FIGS. 1 to 3, those figures show a schematic view, a cross sectional view and an exploded view of the portable viewing apparatus according to a preferred embodiment of the present invention. In this preferred embodiment, the portable viewing apparatus is implemented with LCOS (liquid crystal on silicon) as a micro display, which may be viewed directly or with some auxiliary device such as a microscope.

The portable image viewing apparatus 1 is composed of a casing 10, a micro display 20 and a plurality of buttons 12. The casing 10 is composed of a first shell 110 and a second shell 112 and is ergonomically shaped for ease handling by user's hand. Moreover, the casing 10 is defined a receiving space (not labeled) therein. The buttons 12 are arranged on such places of the casing that user can easily operate them for executing certain functions, for example, viewing next photograph or fast viewing. The buttons 12 are electrically connected with a first circuit board 122 and the first circuit board 122 is electrically connected with the micro display 20. The micro display 20 is place into the receiving space in casing 10.

In addition, a viewing window 14 is provided on the casing 10. At least one transparent glass or lenses is provided inside the viewing window 14, and an adjusting part 16 is placed outside the viewing window 14 to adjust a focal length of the viewing window 14 for observing the micro display 20. The micro display 20 can be observed through the viewing window 14 in ocellar way. The digitalization of X-ray plate is an already know art and is not stated in detail here for simplicity. The portable image viewing apparatus 1 according to the present invention further comprises a built-in memory unit 50 to store digitalized X-ray medial images. Moreover, the portable viewing apparatus may further comprises a microscope (not shown) for facilitating the observation of the micro display 20.

The portable image viewing apparatus 1 further comprises a memory card reader (not shown) electrically connected with the first circuit board 122. The memory card reader can read the stored image data in a memory card, therefore the portable image viewing apparatus 1 can easily access images stored in memory card.

The portable image viewing apparatus 1 further comprises at least one computer connecting port, for example, a USB connecting port 30 or an IEEE1394 connecting port 40. The portable image viewing apparatus 1 can be wired to a computer for data exchange. Alternatively, the portable image viewing apparatus 1 can also include a wireless data unit such as a bluetooth unit to receive medical image data in a wireless way. The invention is not restricted to specific kinds of data access methods.

Furthermore, the memory unit 50 is also electrically connected with a second circuit board 52, and the second circuit board is connected with the micro display 20. The micro display 20 is not restricted to be specific display devices stated in this specification, for example, LED or LCOS. LCOS is a display device with high resolution and low cost, it also conserves power. For this reason, LCOS is more fit for the portable image viewing apparatus 1.

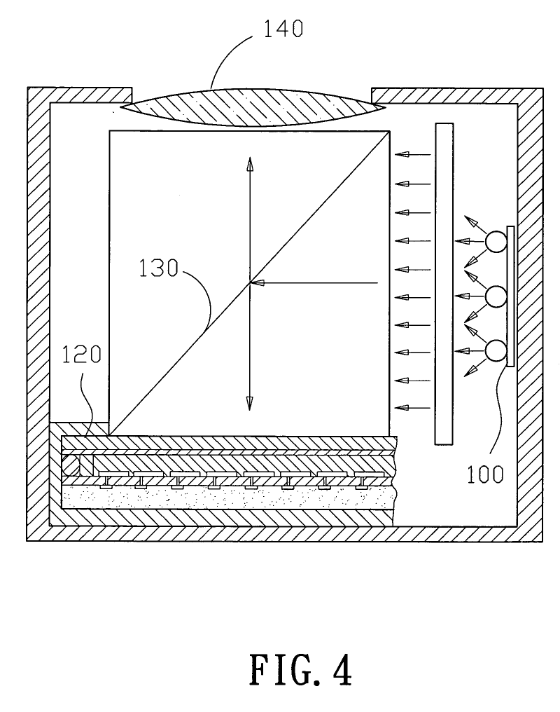

Please refer to FIG. 4, which shows a schematic diagram of the portable image viewing apparatus 1 using LCOS display device. The LCOS display device is a reflective type micro LCD device. The LCOS display device is composed of a CMOS substrate having transistors grown on a silicon wafer, panel formed by semiconductor technology (it's also called CMOS LCD), and an Al-plated mirror. The CMOS substrate is then assembled with a glass substrate having transparent electrode and liquid crystal is injected into the LCOS display device. A light emitted from a light source 100 first passes a lens 110 and is then reflected to an LCOS chip 130 by a reflecting mirror 120. The light is then reflected to a convex lens 140 by the LCOS chip 130.

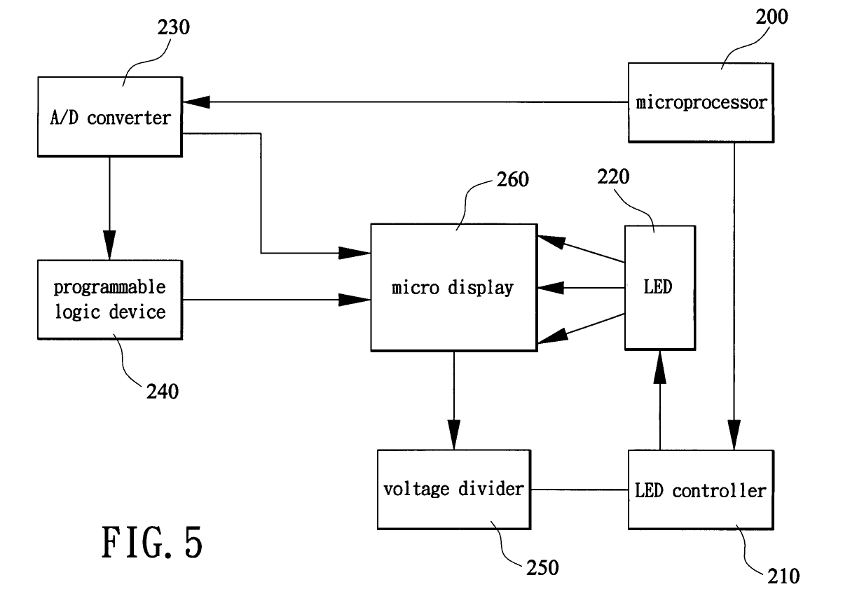

FIG. 5 shows a block diagram of the micro display used in the portable viewing apparatus according to a preferred embodiment of the present invention. A microprocessor 200 is connected with an A/D converter 230 to provide power for a programmable logic device 240 and a micro display 260. The microprocessor 200 can control an LED 220 and a voltage divider 250 by controlling an LED controller 210. However, the A/D converter 230 can be replaced by a DC power supply to enhance portability.

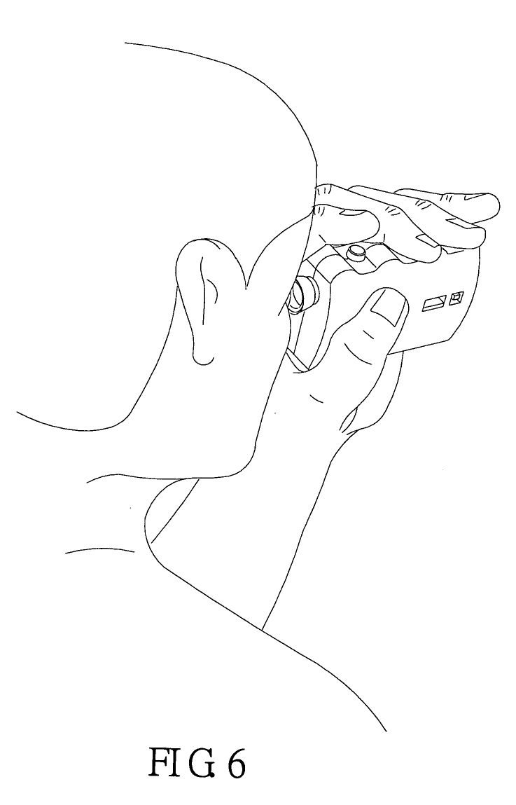

FIG. 6 depicts the application of the portable viewing apparatus according to the present invention.

The present invention is intended to provide an easily carrying and ergonomically portable image viewing apparatus. The apparatus can be operated with one hand. Functional buttons on it are all set on the positions that fingers can hold, for example, next pager or rapidly play etc. Meanwhile, the display apparatus has built-in memory device or can be equipped with card reader to store image data. Moreover, we can store and load image data in computers by connecting them in wired or wireless way. The invention also can be used for multi-connecting in teaching or watching transferring images. The invention display images by a micro display and the micro display is not restricted to certain kind of technique of micro display; it depends on the resolution that users need. LCD or high resolution LCOS are both usable.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A portable image viewing apparatus portable by user's hand to view at least one image, the portable image viewing apparatus comprising:
a casing defining a receiving space therein and having a plurality of buttons provided thereon, at least one viewing window being provided on the casing;
at least one micro display arranged in the receiving space and aligned with the viewing window; and
at least one circuit board arranged in the receiving space and electrically connected to the plurality of buttons and the micro display for driving the micro display to display in image.

2. The portable image viewing apparatus as in claim 1, wherein the plurality of buttons are arranged on such location of the casing that user can easily operate them.

3. The portable image viewing apparatus as in claim 1, further comprising a transparent glass inside the viewing window.

4. The portable image viewing apparatus as in claim 3, wherein the transparent glass is a lens.

5. The portable image viewing apparatus as in claim 1, further comprising an adjusting part placed outside the viewing window to adjust a focal length of the viewing window for observing the micro display.

6. The portable image viewing apparatus as in claim 1, wherein the micro display is an LCD.

7. The portable image viewing apparatus as in claim 1, wherein the micro display is an LCOS.

8. The portable image viewing apparatus as in claim 1, further comprising a memory unit to store image data.

9. The portable image viewing apparatus as in claim 1, further comprising a card reader electrically connected to the circuit board, the portable image viewing apparatus accessing a memory card through the card reader.

10. The portable image viewing apparatus as in claim 1, further comprising a computer connecting port on the casing, the computer connecting port being connected to a computer through a connection wire.

11. The portable image viewing apparatus as in claim 10, wherein the computer connecting port is a USB port.

12. The portable image viewing apparatus as in claim 10, wherein the computer connecting port is an IEEE 1394 port.

13. The portable image viewing apparatus as in claim 1, further comprising a wireless data unit for communicating with a computer with another wireless data unit.

14. The portable image viewing apparatus as in claim 13, wherein the wireless data unit is a bluetooth unit.

15. The portable image viewing apparatus as in claim 1, further comprising a microprocessor for driving the micro display to display in image.

16. The portable image viewing apparatus as in claim 1, further comprising a DC power supply.

17. The portable image viewing apparatus as in claim 1, further comprising a microscope for viewing the micro display.
